(19) United States
(12) Patent Application Publication
(10) Pub. No.: US 2019/0324144 A1
(43) Pub. Date: Oct. 24, 2019

(54) APPARATUS FOR REMOTE MEASUREMENT OF AN OBJECT

(71) Applicant: TROY A. REYNOLDS, WILLS POINT, TX (US)

(72) Inventor: TROY A. REYNOLDS, WILLS POINT, TX (US)

(21) Appl. No.: 16/458,844

(22) Filed: Jul. 1, 2019

Related U.S. Application Data
(63) Continuation-in-part of application No. 15/782,078, filed on Oct. 12, 2017.
(60) Provisional application No. 62/407,561, filed on Oct. 13, 2016.

(51) Int. Cl. G01S 17/10; G01C 9/06; G01S 17/58

(52) U.S. Cl. CPC G01S 17/10; G01S 17/58; G01C 9/06

(57) ABSTRACT

In various aspects, the measurement apparatus disclosed herein includes a body that defines a face oriented toward an object that is to be measured. A laser source is positioned upon the face to emit a laser beam that illuminates the object at a point, and a detector is positioned upon the face that detects a reflection of the laser beam from the point in order to determine a length of the laser beam, in various aspects. A second laser source is positioned upon the face to emit a second laser beam that illuminates the object at a second point distinct from the first point, and a second detector is positioned upon the face to detect a second reflection of the second laser beam from the second point in order to determine a second length of the second laser beam, in various aspects. A user may selectively position the point and the second point upon the object. The second length may be determined simultaneously with the length. The length is used to determine a location of the point and the second length is used to determine a second location of the second point, in various aspects.

### CROSS-REFERENCE TO RELATED APPLICATIONS

This application is a continuation-in-part of U.S. patent application Ser. No. 15/782,078 filed 12 Oct. 2017 that, in turn, claims priority and benefit of U.S. Provisional Patent Application No. 62/407,561 filed 13 Oct. 2016, both of which are hereby incorporated by reference in their entireties herein.

### BACKGROUND OF THE INVENTION

### Field

This disclosure generally relates to apparatus for measuring a surface, and, more particularly, to a measurement apparatus that employs multiple simultaneous laser beams for surface measurement.

### Related Art

Various circumstances arise in which it is necessary to measure an object to determine the size of the object or the size of various features of the object. The object may be, for example, a structure, and it may be necessary to measure certain features of the structure, such as roof dimensions, roof height, chimney height, window dimensions, etc. In certain instances, it may be necessary to measure the overall size of the object. Use of a metering device such as a tape measure, a rule, and a measuring stick, to determine the size of the object or determine the size of various features of the object may be difficult or impractical due to the location or nature of the object or the location or nature of the features. For example, the object may be located in an inaccessible location or the feature(s) of the object to be measured may be elevated or otherwise inaccessible for measurement using the metering device. If the object is in motion, the use of the metering device for measurement may not be possible.

Various optical devices such as a surveyor's transit, a camera, or laser device have been used to determine the size of various features of the object. However, these optical devices may be cumbersome and prone to error. Laser devices employing a single beam determine the distance from the laser device to a feature of the object, but do not determine distances between features of the object at a particular instance in time.

Accordingly, there is a need for improved apparatus as well as related methods for remote measurement of an object.

### BRIEF SUMMARY OF THE INVENTION

These and other needs and disadvantages may be overcome by a measurement apparatus disclosed herein. Additional improvements and advantages may be recognized by those of ordinary skill in the art upon study of the present disclosure.

In various aspects, the measurement apparatus disclosed herein includes a body that defines a face oriented toward an object that is to be measured using the measurement apparatus. A laser source is positioned upon the face to emit a laser beam that illuminates the object at a point, and a detector is positioned upon the face that detects a reflection of the laser beam from the point in order to determine a length of the laser beam, in various aspects. A second laser source is positioned upon the face to emit a second laser beam that illuminates the object at a second point distinct from the first point, and a second detector is positioned upon the face to detect a second reflection of the second laser beam from the second point in order to determine a second length of the second laser beam, in various aspects. The second length may be determined simultaneously with the length. The length is used to determine a location of the point and the second length is used to determine a second location of the second point, in various aspects.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1A illustrates by frontal perspective view portions of an exemplary implementation of a measurement apparatus;

FIG. 1B illustrates by elevation view portions of the exemplary implementation of a measurement apparatus of FIG. 1A;

FIG. 2 illustrates by schematic diagram portions of the exemplary implementation of a measurement apparatus of FIG. 1A;

FIG. 3 illustrates by schematic diagram portions of the exemplary implementation of a measurement apparatus of FIG. 1A;

FIG. 4A illustrates by schematic diagram set in a horizontal plane portions of a second exemplary implementation of a measurement apparatus;

FIG. 4B illustrates by schematic diagram set in a vertical plane portions of the exemplary implementation of a measurement apparatus of FIG. 4A; and,

FIG. 5 illustrates by schematic diagram a third exemplary implementation of a measurement apparatus.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

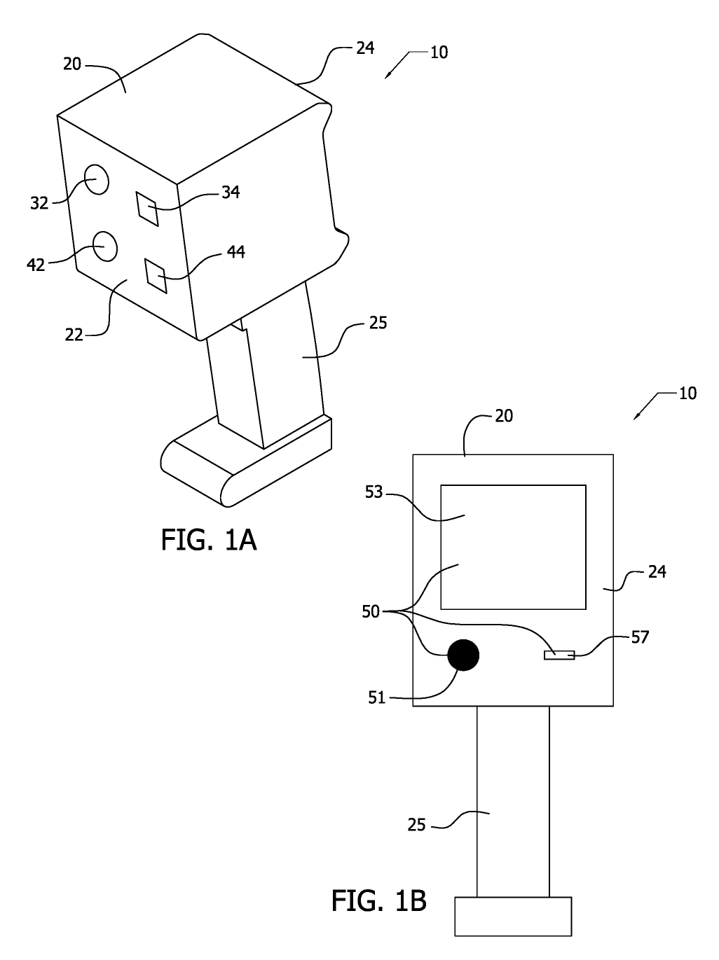

FIG. 1A and 1B illustrate exemplary measurement apparatus 10 that includes body 20 with faces 22, 24. Face 22 is oriented toward object 90, and face 24 is oriented toward a user, as illustrated. Body 20, in this implementation, includes handle 25 that is grippable by the user to allow the user to manipulate body 20, for example, to orient face 22 toward object 90. During operation, the user may hand hold body 20 of measurement apparatus 10 by handle 25. Body 20 may be formed, for example, of various rigid plastics suitable for that purpose. In other implementations, body 20 may be formed, for example, in a generally rectangular shape. In some implementations, body 20 may be mounted, for example, to a stationary platform (not shown) such as a tripod during operation, and various fittings may be provided about body 20 to mount body 20 to the stationary platform, as would be readily recognized by those of ordinary skill in the art upon study of this disclosure.

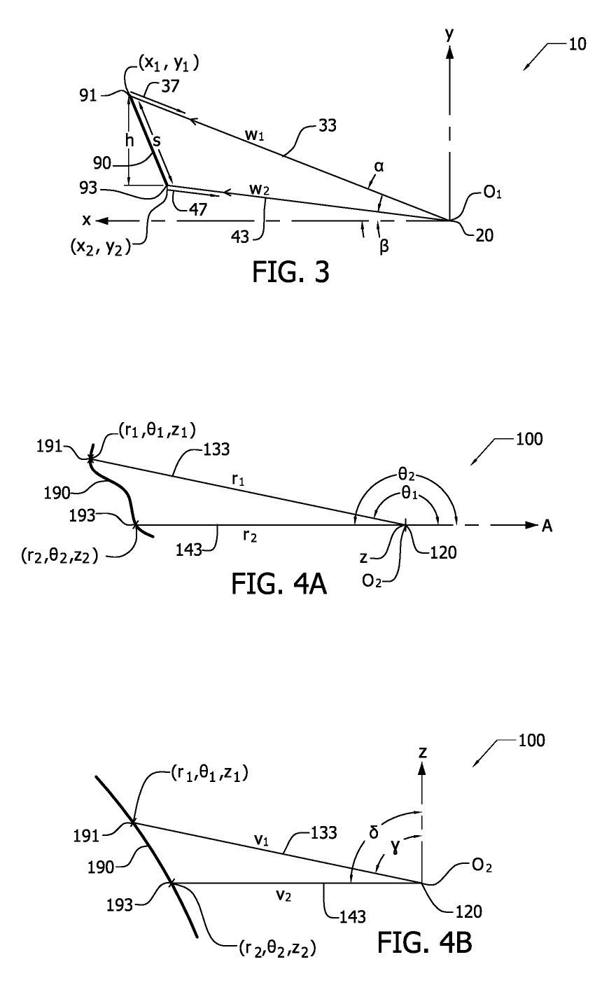

As illustrated in FIG. 1A, laser source 32, detector 34, laser source 42, and detector 44 are mounted on face 22. As illustrated in FIG. 3, laser source 32 emits laser beam 33, and detector 34 detects reflection 37 of laser beam 33 from object 90, where object 90 is some physical entity the user desires to measure. Laser source 42 emits laser beam 43 and detector 44 detects reflection 47 of laser beam 43 from object 90, as illustrated in FIG. 3. Laser sources 32, 42 emit laser beams 33, 43, respectively, as pulsed laser beams. Detectors 34, 44 detect lag between pulses of laser beams 33, 43 and reflections 37, 47 and shifts in wavelengths between laser beams 33, 43 and reflections 37, 47, respectively. Laser beams 33, 43 may range in wavelength from about 250 nm (ultraviolet) to about 10 μm (infrared) and, in certain implementations, laser beams 33, 43 may have a wavelength of from about 600 nm to about 1000 nm. In certain implementations, for example, laser sources 32, 42 in combination with detectors 34, 44 may be configured as a 100 m/328 ft Laser Distance Measuring Sensor Range Finder Module Single Serial TTL signal to PC provided by Arduino of Turin, Italy.

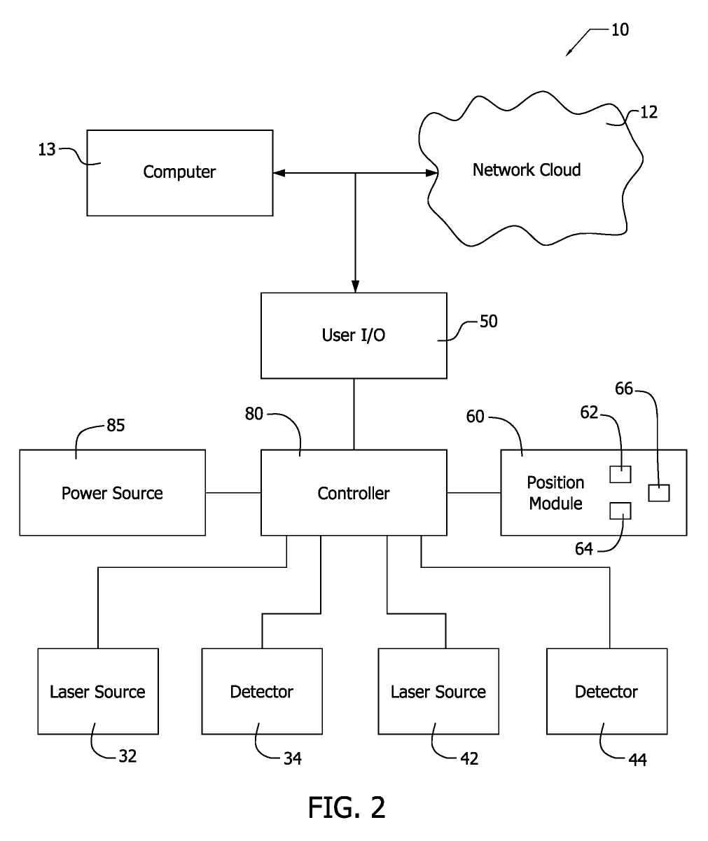

FIG. 1B illustrates face 24 of body 20 that is generally oriented toward the user. Face 24 includes user I/O 50, and user I/O 50 includes display 53, laser position control 51, and data port 57, as illustrated. User I/O 50 may include various switches, push buttons, dials, sliders, graphs, and so forth, whether virtual or physical, for activating or deactivating measurement apparatus 10, obtaining user input from the user, or for data communication. In certain implementations, user I/O 50 may be formed, at least in part, as software operably received by controller 80 (see FIG. 2).

Display 53 of user I/O 50 may be formed as a screen. Display 53 may, for example, display information indicative of the operational status of measurement apparatus 10 or information indicative of measurements made by measurement apparatus 10, and display 53 may display various virtual control(s) for user input.

User I/O 50 includes data port 57 as an interface for communication between, for example, controller 80 and network cloud 12 or between controller 80 and computer 13, in this implementation. Data port 57 may be formed as a physical interface that, for example, conforms to Ethernet (IEEE 802.3), Firewire (IEEE 1394), or USB (e.g., USB 3.2) standards. Data port 57 may be formed as a wireless interface that, for example, conforms to wireless computer networking standards (e.g., IEEE 802.11) or Bluetooth (e.g., IEEE 802.15.1). While data port 57 is illustrated as a physical interface for explanatory purposes, it should be recognized that data port 57 may have other physical and/or virtual configurations, in various implementations.

Network cloud 12 includes, for example, the Internet, local area networks, cell phone networks (e.g. 4G or 5G), text messaging networks (such as MMS or SMS networks), wide area networks, point-to-point connections, and combinations thereof. Network cloud 12 may communicate data using various wired and wireless technologies and combinations of wired and wireless technologies. Network cloud 12 may include various data storage devices, input/output devices, computers, servers, routers, amplifiers, wireless transmitters, wireless receivers, optical devices, and so forth, as would be readily recognized by those of ordinary skill in the art upon study of this disclosure.

Computer 13 may include a computer with one or more processors that may, in various aspects, include memory, display, mouse, keyboard, storage device(s), I/O devices, and so forth. Computer 13 may include, for example, single-processor or multiprocessor computers, minicomputers, mainframe computers, as well as personal computers, hand-held computing devices, mobile devices, cellular telephones, tablets, and other processor-based devices.

User I/O 50 includes laser position control 51 formed as a rotatable knob that, for example, allows the user to select location (x₁, y₁) of point 91 on object 90 illuminated by laser beam 33 emitted from laser source 32 and/or allows the user to select location (x₂, y₂) of point 93 on object 90 illuminated by laser beam 43 emitted from laser source 42, as illustrated in FIG. 3. Both laser beam 33 and laser beam 43 lie along a vertical axis, and rotation of laser position control 51 alters a path of laser beam 33 with respect to the vertical axis thereby altering the location (x₁, y₁) of point 91 illuminated by laser beam 33 and/or alters a path of laser beam 43 with respect to the vertical axis thereby altering the location (x₂, y₂) of point 93 illuminated by laser beam 43, in this implementation. Accordingly, rotation of laser position control 51 alters the angle of laser beam 33 with respect to laser beam 43 with respect to the vertical axis, in this implementation. Points 91, 93 on object 90 may be visible to the user by being illuminated by laser beams 33, 43, respectively. In other implementations, for example, laser beams 33, 43 may lie along a horizontal axis, and rotation of laser position control 51 may alter the angle of laser beam 33 with respect to laser beam 43 in the horizontal plane. In yet other implementations, rotation of laser position control 51 alters the relationship of laser beams 33, 43 with respect to one another in three dimensions. While laser position control 51 is illustrated as a rotatable knob for explanatory purposes, it should be recognized that laser position control 51 may have other physical and/or virtual forms. For example, laser position control 51 may be implemented, at least in part, virtually using display 53, in various implementations.

As illustrated in FIG. 2, measurement apparatus 10 includes controller 80 in operable communication with power source 85, laser source 32, detector 34, laser source 42, detector 44, position module 60, user I/O 50, network cloud 12, and computer 13. Controller 80, position module 60, power source 85, and at least portions of user I/O 50 may be positioned within body 20 of measurement apparatus 10. Various data communication pathways may be provided about body 20 of measurement apparatus 10 for data communication between power source 85, controller 80, laser source 32, detector 34, laser source 42, detector 44, position module 60, user I/O 50, network cloud 12, and computer 13, as would be readily recognized by those of ordinary skill in the art upon study of this disclosure.

Controller 80 may control, at least in part, the operations of power source 85, laser source 32, detector 34, laser source 42, detector 44, position module 60, user I/O 50, in this implementation. Controller 80 may include, for example, a processor, memory, software operably communicating with the processor, A/D converter, D/A converter, clock, I/O connectors, and so forth, and controller 80 may be configured for example, as a single chip or as an array of chips disposed about a circuit board, as would be readily recognized by those of ordinary skill in the art upon study of this disclosure. For example, controller 80 may be a Pro Micro 3.3 V Controller provided by Arduino of Turin, Italy. In some implementations, controller 80 may be configured, at least in part, as software operatively received by a computer, such as computer 13, and the computer may, for example, be in networked communication via data port 57 variously with power source 85, controller 80, laser source 32, detector 34, laser source 42, detector 44, position module 60, and/or user I/O 50.

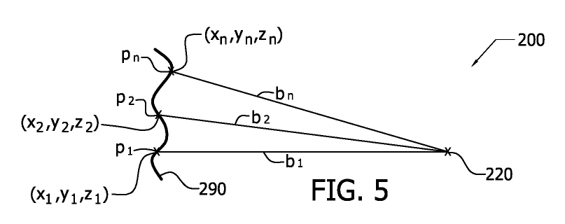

Position module 60 may include an inclinometer 62 to determine an inclination angle, such as inclination angle α, β, γ, δ of laser beams 33, 43, 133, 143, respectively (see FIGS. 3, 4A, 4B). An inclinometer, such as inclinometer 62, may be used to determine inclination angles of laser beams b₁, b₂, . . . bₙ (see FIG. 5).

Position module 60 may include a gyroscope 64 to determine orientation of the laser beams, such as rotation θ₁, θ₂ of laser beams 133, 143, respectively, with respect to reference axis A. Gyroscope 64 may be formed as a microelectromechanical systems (MEMS) gyroscope that, for example, uses lithographically constructed versions of one or more of a tuning fork(s), vibrating wheel(s), or resonant solid(s). The gyroscope, such as gyroscope 64, may be used to determine orientation of laser beams b₁, b₂, . . . , bₙ. The gyroscope, such as gyroscope 64, may be used to stabilize locations, such as locations (x₁, y₁), (x₂, y₂), (r₁, θ₁, z₁), (r₂, θ₂, z₂), (x₁, y₁, z₁), (x₂, y₂, z₂), . . . (xₙ, yₙ, zₙ) of points, such as points 91, 93, 191, 193, p₁, p₂ . . . pₙ on the object, such as object 90, 190, 290, illuminated by laser beams, such as laser beams 33, 43, 133, 143, b₁, b₂, . . . bₙ, when the object, the body, such as body 20, 120, 220, or both the object and the body are in motion.

Position module 60 may include an accelerometer 66 formed, for example, as a three-axis accelerometer that determines the orientation of a body, such as body 20, 120, 220, and, hence, the orientation of laser beams 33, 43, 133, 143, b₁, b₂, . . . bₙ, with respect to an orthogonal coordinate system, such as (x, y), (r, θ, z), (x, y, z), or with respect to GPS coordinates. By continuously determining the orientation of laser beams 33, 43, 133, 143, b₁, b₂, . . . bₙ, with respect to the coordinate system, time variations in the position (e.g., motions) of an object, such as object 90, 190, 290, with respect to a body such as body 20, 120, 220, time variations in the position (e.g., velocity) of the body with respect to the object, or time variations in the positions (e.g., relative velocity) of the object and the body with respect to one another, may be determined. Position module 60 may determine the Global Positioning System (GPS) coordinates of body 20 and/or the GPS coordinates of object 90, in certain implementations.

Power source 85 flows power onto controller 80, laser source 32, detector 34, laser source 42, detector 44, position module 60, and user I/O 50, and various electrical pathways including wires, connectors, switches, transformers, inverters, and so forth are provided about body 20 of measurement apparatus 10 for this purpose, as would be readily recognized by those of ordinary skill in the art upon study of this disclosure. Power source 85 may be, for example, mains electric, battery, or combinations thereof. In certain embodiments, for example, power source 85 may be coterminous with data port 57 with, for example, electrical power being provided through USB connection with data port 57.

In operation of measurement apparatus 10, body 20 is oriented toward object 90 and laser sources 32, 42 are activated to emit laser beams 33, 43 that illuminate object 90 at points 91, 93, respectively, as illustrated in FIG. 3. Laser beams 33, 43 reflect back to detectors 34, 44 from points 91, 93 as reflections 37, 47, and reflections 37, 47 are detected by detectors 34, 44, respectively. The user may use laser position control 51 to adjust a vertical position of points 91, 93 with respect to one another in order to select locations (x₁, y₁), (x₂, y₂). Controller 80 may operatively cooperate with laser sources 32, 42, and detectors 34, 44 to control the emission of laser beams 33, 43, to control detectors 34, 44 including the detection of reflections 37, 47, and to obtain data indicative of pulses of laser beams 33, 43, reflections 37, 47, and shifts in wavelengths between laser beams 33, 43 and reflections 37, 47, respectively.

Controller 80 cooperates with laser sources 32, 42 and with detectors 34, 44 to measure distances w₁ and w₂ using the time of flight of pulses between laser sources 32, 42, points 91, 93, and detectors 34, 44, respectively, based upon the speed of light as a constant (approximately 300,000 km/s).

As illustrated in FIG. 3, locations (x₁, y₁), (x₂, y₂) of points 91, 93, respectively are defined by a two-dimensional Cartesian coordinate system having an x-axis and a y-axis, with the x-axis oriented horizontally and the y-axis oriented vertically orthogonal to the x-axis. Although origin O₁ of the x-axis and y-axis of the Cartesian coordinate system is illustrated as being positioned at body 20 of measurement apparatus 10, origin O₁ may be positioned anywhere as may be convenient. For example, origin O₁ may be specified by GPS coordinates determined, for example, by position module 60. Inclination angle a that laser beam 33 makes with the x-axis (i.e., horizontal axis), and the inclination angle β that laser beam 43 makes with the x-axis are determined, for example, using inclinometer 62 of position module 60. The location (x₁, y₁) of point 91 may be determined by controller 80 from known distances w₁ and inclination angle α, and the location (x₂, y₂) of point 93 may be determined from known distance w₂ and inclination angle β according to:

x₁=w₁ cos α; y₁=w₁ sin α

x₂=w₂ cos β; y₂=w₂ sin β

where x is the horizontal coordinate and y is the vertical coordinate, as illustrated. Locations (x₁, y₁), (x₂, y₂) of points 91, 93, respectively, may be given, for example, with respect to origin O₁ or in GPS coordinates. Then vertical height h of object 90 between points 91, 93 may be found as h=x₁−x₂, and length s of object 90 may be found as s=\sqrt{(x₁−x₂)²+(y₁−y₂)²}, in this implementation. Controller 80 may calculate vertical height h and length s.

Display 53 of user I/O 50 may then variously display distances w₁ and w₂, locations (x₁, y₁), (x₂, y₂) as coordinates with respect to origin O₁, vertical height h, length s, angles α, β, and locations (x₁, y₁), (x₂, y₂) as GPS coordinates. In various implementations, for example, time of flight data obtained from laser sources 32, 42 in cooperation with detectors 34, 44, distances w₁ and w₂, locations (x₁, y₁), (x₂, y₂), vertical height h, length s, angles α, β, and locations (x₁, y₁), (x₂, y₂) as GPS coordinates may be, for example, communicated via networked communication with network cloud 12 via data port 57 or communicated with computer 13 via data port 57. In various implementations, a computer, such as computer 13, located external of body 20 in communication with controller 80 via data port 57 may determine at least some of distances w₁ and w₂, locations (x₁, y₁), (x₂, y₂), vertical height h, length s, angles α, β, and the GPS coordinates of points 91, 93.

FIGS. 4A, 4B illustrates exemplary measurement apparatus 100 including laser beams 133, 143 being emitted simultaneously from laser sources, such as laser source 32, 42, placed about body 120. Points 191, 193 on object 190 are set apart from one another both horizontally, as illustrated in FIG. 4A, and vertically, as illustrated in FIG. 4B, and, thus, the locations of points 191, 193 are defined using three-dimensional cylindrical coordinates r, θ, z where r is the radial distance from origin O₂ centered at body 120, rotation θ is an angle with respect to reference axis A that extends from origin O₂ in the radial direction in a horizontal plane, and z is the axial coordinate (vertical axis). The z-axis is normal to the Earth's surface and reference axis A lies in the horizontal plane normal to the z-axis, as illustrated. Accordingly, points 191, 193 have locations (r₁, θ₁, z₁) and (r₂, θ₂, z₂), respectively, as illustrated.

As illustrated in FIGS. 4A, 4B, laser beams 133, 143 illuminate points 191, 193, and laser beams 133, 143 have lengths v₁, v₂, respectively, as measured by time of flight. Laser beams 133, 143 form angles of rotation θ₁, θ₂ with reference axis A as measured by position module 60, as illustrated in FIG. 4A. As illustrated in FIG. 4B, laser beams 133, 143 form inclination angles γ, δ respectively, with the z-axis (i.e., vertical axis), so that radial and axial coordinates of points 191, 193 are r₁=v₁ sin γ; z₁=v₁ cos γ and r₂=v₂ sin δ; z₂=v₂ cos δ. Inclination angles γ, δ may be determined by a position module, such as position module 60, and a controller, such as controller 80, may perform calculations necessary to determine lengths v₁ and v₂ and locations (r₁, θ₁, z₁) and (r₂, θ₂, z₂).

If object 190 is in motion, then locations (r₁, θ₁, z₁) and (r₂, θ₂, z₂) are functions of time t, that is: r₁=r₁(t); θ₁=θ₁(t); z₁=z₁(t) and r₂=r₂(t); θ₂=θ₂(t); z₂=z₂(t). Then by measuring time rates of change of lengths

$$\frac{{dv}_{1}}{dt} and \frac{{dv}_{2}}{dt}$$

and rates of change of angles of rotation

$$\frac{d {θ}_{1}}{dt} and \frac{d {θ}_{2}}{dt} ,$$

measurement apparatus 100 can calculate

$${\vec{V}}_{1} = \frac{d}{dt} ( {r}_{1} , {θ}_{1} , {z}_{1} ) and {\vec{V}}_{2} = \frac{d}{dt} ( {r}_{2} , {θ}_{2} , {z}_{2} ) ,$$

where \vec{V}₁ and \vec{V}₂ are the velocity vectors of points 191, 193 on object 190 with respect to origin O₂, for example. If object 190 is rigid, then velocity vectors \vec{V}₁ and \vec{V}₂ may be indicatvie of the velocity of object 190. A controller, such as controller 80, may perform calculations necessary to determine velocity vectors \vec{V}₁ and \vec{V}₂.

FIG. 5 illustrates exemplary measurement apparatus 200 including laser beams b₁, b₂, . . . bₙ being emitted simultaneously from n laser sources, such as laser source 32, 42, disposed about body 220. The n laser beams b₁, b₂, . . . bₙ illuminate simultaneously n discrete points p₁, p₂, . . . pₙ an object 290 to define the locations (x₁, y₁, z₁), (x₂, y₂, z₂), . . . (xₙ, yₙ, zₙ) of the n discrete points p₁, p₂, . . . pₙ simultaneously in three-dimensional Cartesian coordinates, in this implementation. Simultaneous velocities \vec{V}₁, \vec{V}₂, . . . \vec{V}ₙ of the n discrete points p₁, p₂, . . . pₙ may be determined from time rates of change of the corresponding locations (x₁, y₁, z₁), (x₂, y₂, z₂), . . . (xₙ, yₙ, zₙ).

The number of laser beams n may range from 2 to many thousands, for example, in measurement apparatus 200. Note that object 290 presents a contorted surface and that coordinates of the n discrete points p₁, p₂, . . . pₙ from a representation of the surface of object 290, in this implementation. Increasing the number of laser beams n, and, thus, increasing the number of discrete points p₁, p₂, . . . pₙ increases the density of the representation of the surface of object 290 and, hence, may increase the accuracy of the representation of the surface of object 290.

It should be recognized that the examples of FIGS. 3, 4A, 4B, 5 are illustrative, not limiting. While points 91, 93 have locations (x₁, y₁), (x₂, y₂), respectively, defined in Cartesian coordinates, points 191, 193 have locations (r₁, θ₁, z₁), (r₂, θ₂, z₂), respectively, defined in cylindrical coordinates, and points p₁, p₂, . . . pₙ have locations (x₁, y₁, z₁), (x₂, y₂, z₂), . . . (xₙ, yₙ, zₙ) defined in three-dimensional Cartesian coordinates, it should be recognized that other orthogonal coordinates systems may be used to locate points 91, 93, 191, 193, p₁, p₂, . . . pₙ in two dimensions or in three dimensions, as required, and that the locations of points 91, 93, 191, 193, p₁, p₂, . . . pₙ may be transformed between various orthogonal coordinate systems. Velocity vectors, such as velocity vectors \vec{V}₁ and \vec{V}₂ are vector quantities that may be expressed in any orthogonal coordinate system.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72(b) only. Accordingly, the Abstract is not intended to identify key elements of the apparatus and methods disclosed herein or to delineate the scope thereof. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. A measurement apparatus, comprising:
a body that defines a face oriented toward an object;
a laser source positioned upon the face to emit a laser beam that illuminates the object at a point;
a detector positioned upon the face that detects a reflection of the laser beam from the point in order to determine a length of the laser beam;
a second laser source positioned upon the face to emit a second laser beam that illuminates the object at a second point;
a second detector positioned upon the face that detects a second reflection of the second laser beam from the second point in order to determine a second length of the second laser beam, the second length determined simultaneously with the length;
and wherein the length is used to determine a location of the point and the second length is used to determine a second location of the second point.

2. The apparatus of claim 1, further comprising:
a position module to determine an inclination angle of the laser beam and a second inclination angle of the second laser beam.

3. The apparatus of claim 2, wherein the position module determines an angle of rotation of the laser beam with respect to a reference axis in a horizontal plane and a second angle of rotation of the second laser beam with respect to the reference axis in the horizontal plane.

4. The apparatus of claim 2, wherein the position module determines a location of the body.

5. The apparatus of claim 2, wherein the position module determines an orientation of the body.

6. The apparatus of claim 1, further comprising:
a laser position control to selectively position the point and the second point upon the object.

7. The apparatus of claim 1, wherein the laser beam and the second laser beam lie along a vertical axis.

8. The apparatus of claim 1, wherein the laser beam and the second laser beam lie along a horizontal axis.

9. The apparatus of claim 1, wherein the laser beam and the second laser beam define a line that forms an acute angle with respect to a horizontal axis.

10. The apparatus of claim 1, wherein the location and the second location are defined by two coordinates in a two-dimensional orthogonal coordinate system.

11. The apparatus of claim 1, wherein the location and the second location are defined by three coordinates in a three-dimensional orthogonal coordinate system.

12. The apparatus of claim 1, wherein the location and the second location are communicated via a network cloud.

13. The apparatus of claim 1, wherein a rate of change of the length is determined from the reflection of the laser beam indicative of a velocity of the point.

14. The apparatus of claim 13, wherein a second rate of change of the second length is determined from the second reflection of the second laser beam indicative of a second velocity of the second point simultaneous with the velocity of the point.

15. A measurement apparatus, comprising:
a body that defines a face oriented toward an object;
at least three laser sources positioned upon the face, each laser source emits a laser beam that illuminates the object at a point;
detectors positioned upon the face, each detector corresponds uniquely to one of the laser sources, each detector detects a reflection of the laser beam emitted by the corresponding source from the point in order to determine a length of the laser beam emitted by the corresponding laser source;
wherein the length is used to determine a location of the point on the object illuminated by the corresponding laser beam.

16. The measurement apparatus of claim 15, wherein a rate of change of each length is used to determine a velocity of the point on the object illuminated by the corresponding laser beam.
